(19) United States
(12) Patent Application Publication
(10) Pub. No.: US 2024/0399645 A1
(43) Pub. Date: Dec. 5, 2024

(54) METHOD FOR DOUBLE-SHEET THERMOFORMING OF A HOLLOW BODY AND RESULTING HOLLOW BODY

(71) Applicant: ARKEMA FRANCE, COLOMBES (FR)

(72) Inventors: Pierre GONNETAN, Serquigny (FR); Clément PAUL, Serquigny (FR); Philippe BUSSI, Colombes Cedex (FR); Olivier RODARY, Thise (FR)

(73) Assignee: ARKEMA FRANCE, COLOMBES (FR)

(21) Appl. No.: 18/700,396

(22) PCT Filed: Oct. 11, 2022
(86) PCT No.: PCT/FR2022/051909

§ 371 Date: Apr. 11, 2024

(30) Foreign Application Priority Data
Oct. 12, 2021 (FR) FR2110778

(51) Int. Cl. B29C 51/00; B29C 51/10; B29C 51/42; B29K 71/00

(52) U.S. Cl. CPC B29C 51/002; B29C 51/105; B29C 51/42; B29K 2071/00; B29K 2995/0039; B29K 2995/0041

(57) ABSTRACT

The use of sheets comprising at least one face consisting of a pseudo-amorphous composition based on polyaryl ether ketone(s) for a twin sheet thermoforming process. A twin sheet thermoforming process for manufacturing a hollow body. A hollow body comprising at least one internal surface consisting of a crystallized composition based on polyaryl ether ketone(s), obtainable by the process.

### TECHNICAL FIELD

The invention relates to the field of twin sheet thermoforming processes for a hollow body.

More precisely, the invention relates to such processes using sheets based on polyaryl ether ketone(s).

### PRIOR ART

Polyaryl ether ketones are well-known high-performance engineering polymers. They may be used for applications which are restrictive in terms of temperature and/or in terms of mechanical constraints, or even chemical constraints. They can also be used for applications requiring excellent fire resistance and low emission of smoke or toxic gases. Finally, they have good biocompatibility. These polymers are found in fields as varied as aeronautics and space, offshore drilling, automotive, rail, marine, wind power, sports, construction, electronics or else medical implants.

Processes for twin sheet thermoforming of thermoplastics are also known from the prior art. In particular they permit the production of hollow rigid articles.

A twin sheet thermoforming process involves thermoforming two sheets to form two halves of an article and welding these halves together to form a hollow article.

Two processes are known in particular.

According to a first process, two thermoplastic polymer sheets are placed in a clamping frame and heated simultaneously. When the sheets have reached the forming temperature, i.e., are sufficiently softened, air is forced between the sheets and/or a vacuum is applied to the outer part of the sheets, pressing them against two mold halves that can be closed and pressed against each other, allowing a pinching effect.

According to a second process, the two sheets are sequentially thermoformed in their respective mold halves. The two mold halves are then closed and pressed against each other, allowing the pinching effect.

An example of implementation with thermoplastic polymers having a high heat deflection temperature (HHDT) is described in U.S. Pat. No. 5,114,767 A2. HHDT polymers in the sense of this technology include polyetherimides, polyamideimides, polyimides, polysulfones, a polyether sulfone, a polyphenylsulfone, a polyetheretherketone, a polyetherketoneketone, a polyaryl sulfone, aromatic polyamides, polyarylsulfones, and polyphenylether/polystyrene mixtures.

Two layers of thermoplastic HHDT polymer, such as those stated above, are first heated above their deflection temperature and placed between two mold halves heated to a temperature below said deflection temperature. A layer of a low heat deflection temperature polymer (LHDT) is interposed between the two layers of thermoplastic HHDT polymer. The two mold halves are then closed against each other, the adhesion between the two layers of HHDT polymer being ensured by the presence of the LHDT polymer.

Lastly, a hollow body is formed by injection of gas into the mold.

This technique has the disadvantage of necessitating the addition of an adhesion layer between the two layers intended mainly to form the hollow body.

There is currently a need to use polyaryl ether ketones in thermoforming processes in order to manufacture high-performance crystallized hollow bodies.

The present invention provides a twin sheet thermoforming process comprising at least two sheets of polyaryl ether ketone(s) capable of crystallizing without requiring an additional intermediate layer.

### SUMMARY OF THE INVENTION

The invention relates to a twin sheet thermoforming process for manufacturing a hollow body. The process comprises:
supplying two sheets comprising at least one face consisting of a pseudo-amorphous composition based on polyaryl ether ketone(s);
a step of softening the two sheets at a softening temperature, so as to form softened sheets,
   the softening temperature being greater than or equal to the glass transition temperature of each pseudo-amorphous composition;
a step of forming softened sheets so as to form thermoformed sheets;
a step of contacting and coalescing at least one contact zone of said faces of the softened sheets, and/or
   of sheets being formed or already formed,
   so as to form an intermediate body, the contact zones being heated to a contacting temperature, each contact zone remaining in an essentially amorphous state at least until contacting; and
a step of crystallizing the composition at a mold temperature, to form a crystallized hollow body,
   the crystallization step being carried out essentially after the contacting and coalescing step, and preferably essentially after the forming step.

Advantageously, the composition may have a viscosity at 380° C., at 1 Hz, as measured by a parallel plate rheometer, ranging from 200 Pa·s to 8000 Pa·s, preferably from 500 Pa·s to 5000 Pa·s, and more preferably from 750 Pa·s to 4500 Pa·s.

Advantageously, the isothermal crystallization half-time at the contact temperature of the composition may be at least 3 seconds, preferably at least 5 seconds, and most preferably at least 8 seconds; and/or not more than 30 minutes, preferably not more than 10 minutes, more preferably not more than 5 minutes, and most preferably not more than 2 minutes.

According to some embodiments, the polyaryl ether ketone(s) may be a polyether ketone ketone. It may preferably be a homopolymer or copolymer essentially consisting of, or consisting of, at least one isophthalic repeating unit (I), having the chemical formula:

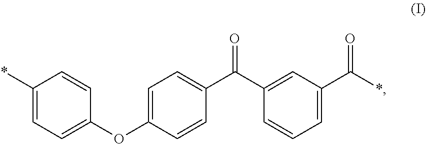

and in the case of the copolymer, a terephthalic repeating unit (T), having the chemical formula:

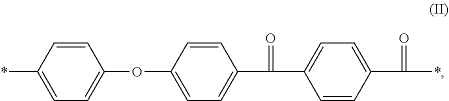

the molar percentage of T units relative to the sum of the T and I units being from 0% to 5% or from 35% to 78%, preferably from 45% to 75%, and extremely preferably from 48% to 52% or from 65% to 74%.

According to some embodiments, the polyaryl ether ketone(s) may be a copolymer consisting essentially of, or consisting of, a repeating unit of the formula:

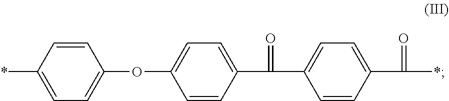

and a repeating unit of formula:

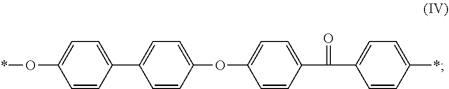

the molar percentage of unit (III), relative to the sum of the units (III) and (IV), being from: 0% to 99%, preferably from 5% to 95%, more preferably from 10% to 50% and most preferably from 20% to 40%.

According to some embodiments, the polyaryl ether ketone(s) may be a copolymer consisting essentially of, or consisting of, a repeating unit having the formula:

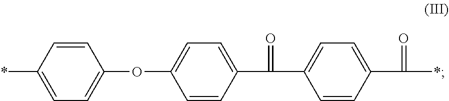

and a repeating unit having the formula:

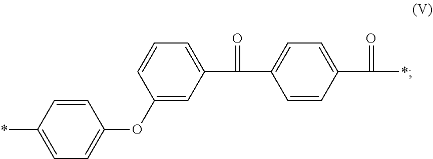

the molar percentage of unit (III) relative to the sum of the units (III) and (V) being from 0% to 99% and preferably from 0% to 95%.

According to some embodiments, the composition may comprise at least one other thermoplastic polymer different from a polyaryl ether ketone and/or may comprise at least one filler and/or may comprise at least one additive.

According to some embodiments, the composition may consist of the polyaryl ether ketone(s), optionally one or more other thermoplastic polymer(s) different from a polyaryl ether ketone, optionally one or more fillers, and optionally one or more additives.

According to some embodiments, each sheet may consist, independently or not of each other, of a pseudo-amorphous composition based on polyaryl ether ketone(s).

Advantageously, the two sheets may have, independently or not of each other, a thickness of 200 microns to 20 millimeters, preferably a thickness of 500 microns to 10 millimeters.

Advantageously, the crystallization step can be carried out to an average degree of crystallinity in the thickness of strictly greater than 7%, as measured by WAXS, during the crystallization step; preferably to a degree of crystallinity greater than or equal to 10%, or greater than or equal to 15%, or greater than or equal to 20%, or even greater than or equal to 25%.

Advantageously, the softening step can be carried out with a softening temperature having a value strictly greater than Tg and less than or equal to (Tg+80°) C, and preferably having a value ranging from (Tg+10°) C to (Tg+75° C.)

Advantageously, the crystallization step can be carried out at a mold temperature close to the temperature at which the composition exhibits a minimum isothermal crystallization half-time.

Advantageously, the difference between the mold temperature and the softening temperature is less than or equal to 50° C., and preferably greater than or equal to 15° C.

According to some embodiments, the contacting and coalescing step is carried out with a pinching pressure having a value ranging from 1 bar to 50 bar, preferably with a pinching pressure having a value ranging from 5 bar to 40 bar, and more preferably with a pinching pressure having a value ranging from 7 bar to 30 bar.

The invention also relates to a hollow body comprising at least one internal surface consisting of a crystallized composition based on polyaryl ether ketone(s), obtainable by a process as described above.

The present invention is based on the use by the inventors of sheets comprising at least one face consisting of a pseudo-amorphous composition based on polyaryl ether ketone(s) for a twin sheet thermoforming process for manufacturing a hollow body. The use of such sheets can in particular be implemented in a process such as those described above. These sheets make it possible to implement a good quality heat seal at the contact zone between the sheets, since the composition of each sheet remains in an essentially amorphous state until the compositions are brought into contact and coalescence. The composition of each sheet is nevertheless crystallizable and crystallizes after the compositions have been brought into contact and coalescence. The inventors have thus been able to exploit the particularly advantageous crystallization kinetics of pseudo-amorphous polyaryl ether ketone(s) to use a hollow body crystallized from sheets of pseudo-amorphous composition(s) based on polyaryl ether ketone(s), without the need to resort to an adhesive intermediate layer.

### FIGURES

FIG. 1 is a diagram of a twin sheet thermoforming device.

FIG. 2 is a block diagram showing the main steps of a twin sheet thermoforming process according to a first embodiment and for which the device according to FIG. 1 is particularly suitable.

### DETAILED DESCRIPTION OF THE INVENTION

### Definitions

The term “glass transition temperature”, written as T_{g}, means the temperature at which a polymer, at least partially amorphous, changes from a rubbery state to a glassy state, or vice versa, as measured by differential scanning calorimetry (DSC) according to standard NF ISO 11357-2:2020, on second heating, using a heating rate of 20° C./min.

In the present invention, when reference is made to a glass transition temperature, it relates more particularly, unless otherwise indicated, to the glass transition temperature at half the height of the step, as defined in this standard. The compositions based on PAEK(s) in the present invention may optionally exhibit several glass transition levels in the DSC analysis, in particular due, where appropriate, to the presence of several different immiscible polymers. In this case, the term “glass transition temperature” is understood to mean the highest glass transition temperature corresponding to the glass transition step of the PAEK or of the mixture of PAEKs.

The term “melting temperature”, written as T_{f}, means the temperature at which an at least partially crystallized polymer changes to the viscous liquid state, as measured by differential scanning calorimetry (DSC) according to standard NF EN ISO 11357-3:2018, on first heating, using a heating rate of 20° C./min. In the present invention, when reference is made to a melting temperature, it is more particularly, unless otherwise indicated, the peak melting temperature as defined in this standard. The compositions based on PAEK(s) in the present invention may optionally exhibit several melting peaks in the DSC analysis, in particular due and/or for a given polymer to the presence of different crystalline forms. In this case, the melting temperature is understood to mean the melting temperature corresponding to the melting peak which is the highest in temperature.

The term “pseudo-amorphous” polymer, respectively “pseudo-amorphous” composition, is understood to denote a polymer, respectively a composition, that is at a temperature below its glass transition temperature in essentially amorphous form. The polymer, or the composition, is nevertheless capable of crystallizing once heated to a temperature above its glass transition temperature for a sufficient period of time. Within the meaning of the invention, a “pseudo-amorphous” polymer, or a “pseudo-amorphous” composition respectively, has a degree of crystallinity of 0% to 7% at 25° C.

The “degree of crystallinity” may be measured by WAXS. For example, the analysis can be performed in wide angle X-ray scattering (WAXS), on a Nano-inXider® instrument with the following conditions:
Wavelength: main Kα1 line of copper (1.54 angström).
Generator power: 50 kV-0.6 mA.
Mode of observation: transmission.
Counting time: 10 minutes.

A spectrum of the scattered intensity as a function of the diffraction angle is thus obtained. This spectrum makes it possible to identify the presence of crystals, when peaks are visible on the spectrum in addition to the amorphous halo.

In the spectrum, it is possible to measure the area of the crystalline peaks (denoted CA) and the area of the amorphous halo (denoted AH). The proportion by mass of crystalline PEKK in the PEKK is then estimated using the ratio (CA)/(CA+AH).

The expression “isothermal crystallization half-time”, written as “t½” at a measurement temperature, is understood to mean the time necessary to reach a relative crystallinity of 0.5 for isothermal crystallization at the measurement temperature, as defined according to standard ISO 11357-7:2015.

According to this standard, the isothermal crystallization conditions are implemented by a first step of melting a specimen and then cooling as quickly as possible to the chosen measurement temperature so that crystallization begins after the end of the cooling step. The time at which the isothermal step ends, that is to say the time necessary to obtain a complete crystallization curve, depends on the crystallization rate. In the absence of clarity of the DSC curve, this time is fixed at five times the time necessary to reach the maximum crystallization rate.

The term “mixture of polymers” is understood to denote a macroscopically homogeneous composition of polymers. The term encompasses mixtures of compatible and/or miscible polymers, the mixture having a glass transition temperature intermediate to those of its polymers considered individually. The term also encompasses such compositions composed of phases immiscible with each other and dispersed on the micrometric scale.

The term “copolymer” is intended to denote a polymer derived from the copolymerization of at least two chemically different types of monomer, referred to as comonomers. A copolymer is thus formed of at least two repeat units. It can also be formed of three or more repeat units.

The acronym ‘PAEK’ stands for ‘polyaryl ether ketone’, ‘PAEKs’ stands for ‘polyaryl ether ketones’, and ‘PAEK(s)’ stands for ‘polyaryl ether ketone or polyaryl ether ketones’.

In all the ranges set out in the present patent application, the endpoints are included, unless otherwise stated.

### Pseudo-Amorphous Composition Based on Polyaryl Ether Ketone(s)

The composition based on polyaryl ether ketone(s) in sheet form for the process according to the invention is pseudo-amorphous.

It is the essentially amorphous nature of the composition that allows good coalescence of the peripheral zones of the sheets brought into contact in the twin sheet thermoforming process. This is why the at least one polyaryl ether ketone, or the composition comprising it, advantageously has a degree of crystallinity of less than or equal to 5.0%, or less than or equal to 3.0%, or else less than or equal to 1.0%, and ideally of about 0%.

The composition must have a crystallization rate at a temperature between T_{f} and T_{g} slow enough to permit sheets to form in the pseudo-amorphous state.

The composition must also have a crystallization rate between T_{f} and T_{g} slow enough to remain in an essentially amorphous state during the softening step and up to the contacting step.

On the other hand, the composition must have a crystallization rate between T_{f} and T_{g} fast enough to be able to crystallize within a reasonable time scale after the contacting and coalescing step.

Advantageously, the isothermal crystallization half-time of the composition at the softening temperature and/or at the contact temperature may be at least 3 seconds and at most 30 minutes.

The isothermal crystallization half-time of the composition at the softening temperature and/or at the contact temperature may preferably be at least 5 seconds, and more preferably at least 8 seconds.

The isothermal crystallization half-time of the composition at the softening temperature and/or at the contact temperature may preferably be at most 10 minutes, more preferably at most 5 minutes, and extremely preferably at most 2 minutes.

Advantageously, the viscosity of the composition at 380° C. and 1 Hz, as measured with a parallel plate rheometer 25 mm in diameter, under nitrogen purging, has a value of 200 Pa·s to 8000 Pa·s, preferably of 500 Pa·s to 5000 Pa·s, and more preferably of 750 Pa·s to 4500 Pa·s.

These viscosity ranges are in particular advantageous for making it possible to obtain a sheet having good strength and a substantially homogeneous thickness during extrusion of the sheet, a reasonable creep resistance during the step of forming softened sheets, and finally to allow good coalescence during the step of bringing the two sheets into contact and coalescence with each other.

In particular, the composition may have a viscosity having a value of: 750 Pa·s to 1200 Pa·s, or 1200 Pa·s to 1600 Pa·s, or 1600 Pa·s to 2000 Pa·s, or 2000 Pa·s to 2400 Pa·s, or 2400 Pa·s to 2800 Pa·s, or 2800 Pa·s to 3200 Pa·s, or 3200 Pa·s to 3600 Pa·s, or 3600 Pa·s to 4000 Pa·s, or 4000 Pa·s to 4250 Pa·s, or 4250 Pa·s to 4500 Pa·s.

The composition preferably has a glass transition temperature T_{g} of greater than or equal to 125° C., more preferably greater than or equal to 145° C., and extremely preferably greater than or equal to 150° C.

The composition preferably has a melting temperature T_{f} of greater than or equal to 250° C., and more preferably greater than or equal to 270° C. The composition may in particular have a melting temperature of greater than or equal to 280° C., or greater than or equal to 290° C., or greater than or equal to 300° C., or greater than or equal to 310° C., or greater than or equal to 320° C., or even greater than or equal to 330° C.

The composition comprises at least 50% by weight of at least one polyaryl ether ketone. It is interchangeably denoted in the rest of the application as a composition based on polyaryl ether ketone(s).

A polyaryl ether ketone (PAEK) comprises the units of the following formulae:

(—Ar—X—) and (—Ar₁—Y—),

wherein:
Ar and Ar₁ each denote a divalent aromatic radical;
Ar and Ar₁ can be chosen preferably from 1,3-phenylene, 1,4-phenylene, 1,1′-biphenylene divalent in 3,3′ positions, 1,1′-biphenyl divalent in 3,4′ positions, 1,4-naphthylene, 1,5-naphthylene and 2,6-naphthylene;
X denotes an electron-withdrawing group; it can be chosen preferably from the carbonyl group and the sulfonyl group;
Y denotes a group chosen from an oxygen atom, a sulfur atom, an alkylene group, such as —(CH)₂— and isopropylidene.

In these X and Y units, at least 50%, preferably at least 70% and more particularly at least 80% of the groups X are a carbonyl group, and at least 50%, preferably at least 70% and more particularly at least 80% of the groups Y represent an oxygen atom.

According to a preferred embodiment, 100% of the groups X denote a carbonyl group and 100% of the groups Y represent an oxygen atom.

The weight of PAEK or, where appropriate, the sum of the weights of the PAEKs of the composition may represent at least 60%, or at least 70%, or at least 80%, or at least 85%, or at least 90%, or at least 92.5%, or at least 95%, or at least 99%, or at least 99.9% or 100% of the total weight of the composition.

In certain embodiments, the composition consists essentially of PAEK(s), i.e., it comprises PAEK(s) at from 90% to 99.9% of the total weight of composition.

In some embodiments, the composition consists of PAEK(s), i.e., it consists of PAEK(s) at at least 99.9%, ideally 100%, of the total weight of composition.

Advantageously, the PAEK(s) may be chosen from:
a polyetherketoneketone, also known as PEKK; a PEKK comprises one or more units of formula: -Ph-O-Ph-C(O)-Ph-C(O)—;
a polyetheretherketone, also known as PEEK; a PEEK comprises one or more units of formula: -Ph-O-Ph-O-Ph-C(O)—;
a polyetherketone, also known as PEK; a PEK comprises one or more units of formula: -Ph-O-Ph-C(O)—;
a polyetheretherketoneketone, also known as PEEKK; a PEEKK comprises one or more units of formula: -Ph-O-Ph-O-Ph-C(O)-Ph-C(O)—;
a polyetheretheretherketone, also known as PEEEK; a PEEEK comprises one or more units of formula: -Ph-O-Ph-O-Ph-O-Ph-C(O)—;
a polyetherdiphenyletherketone, also known as PEDEK; a PEDEK comprises one or more units of formula: a PEDEK comprises one or more units of formula -Ph-O-Ph-Ph-O-Ph-C(O)—;
mixtures thereof; and
copolymers comprising at least two of the abovementioned units,
   wherein: Ph represents a phenylene group and —C(O)— represents a carbonyl group, it being possible for each of the phenylenes independently to be of ortho (1,2), meta (1,3) or para (1,4) type, preferentially being of meta or para type.

In addition, defects, end groups and/or monomers can be incorporated in a very small amount in the polymers as described in the above list, without, however, having an effect on their performance.

According to some embodiments, the composition comprises, consists essentially of, or even consists of, a polyetherketoneketone polymer comprising:
a terephthalic unit and an isophthalic unit, the terephthalic unit having the formula:

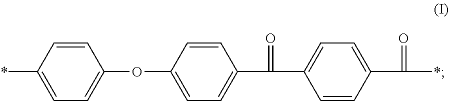

the isophthalic unit having the formula:

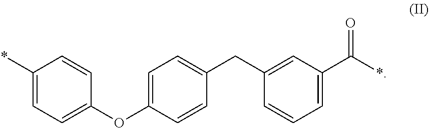

For a polymer of a given family, such as the PEKKs family, ‘comprises one or more units’ means that this/these unit(s) have a total molar proportion of at least 50% in the polymer. This/these unit(s) may represent a molar proportion of at least 60%, or at least 70%, or at least 80%, or at least 85%, or at least 90%, or at least 92.5%, or at least 95%, or at least 99%, or at least 99.9% in the polymer. The expression “essentially consisting of unit(s)” means that the unit(s) represent(s) a molar proportion of 95% to 99.9% in the copolymer. Finally, the term “consisting of unit(s)” is understood to mean that the unit(s) represent a molar proportion of at least 99.9% in the polymer.

Preferably, the polyetherketoneketone consists essentially of, or even consists of: isophthalic “I” and terephthalic “T” units.

Preferably, the polyetherketoneketone is, where appropriate, a random copolymer.

The choice of the molar proportion of T units with respect to the sum of the T and I units is one of the factors that makes it possible to adjust the crystallization rate properties of polyetherketoneketones.

A given molar proportion of T units, relative to the sum of the T and I units, can be obtained by adjusting the respective concentrations of the reactants during the polymerization, in a manner known per se.

The molar proportion of T units relative to the sum of the T and I units of PEKK(s) may notably range from: 0% to 5%; or 5% to 10%; or 10% to 15%; or 15% to 20%; or 20% to 25%; or 25% to 30%; or 30% to 35%; or 35% to 40%; or 40% to 45%; or 45% to 48%, or 48% to 51%, or 51% to 54%, or 54% to 58%, or 58% to 62%, or 62% to 65%, or 65% to 68%; or 68% to 73% or 73% to 75%; or 75% to 78%; or 78% to 80%; or 80% to 85%.

According to particular embodiments, the polyetherketoneketone essentially consists of, or even consists of, “T” and “I” units, with a molar proportion of T units relative to the sum of the T and I units ranging from 0% to 5% or from 35% to 78%. Indeed, for this range of molar proportions, a polyetherketoneketone has an appropriate crystallization rate, allowing it on the one hand to be obtained in essentially amorphous form by sufficiently rapid cooling and to crystallize sufficiently rapidly once heated above its glass transition temperature. These molar proportions of units T relative to the sum of the units T and I are therefore particularly appropriate for compositions essentially consisting of, or even consisting of, a single polyetherketoneketone. The molar proportion of T units relative to the sum of the T and I units may preferably be from 0% to 5% or from 35% to 78%, preferably from 45% to 75% and more preferably from 48% to 52% or from 65% to 74%. The molar proportion of T units with respect to the sum of the T and I units may in particular be about 50% or about 70%.

The composition preferably does not consist of a polyetheretherketone homopolymer consisting of a single repeating unit of formula:

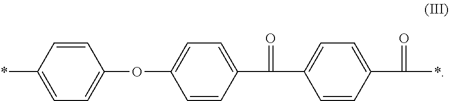

Indeed, this polymer crystallizes very quickly when heated above its Tg, which makes it very difficult to form thick pseudo-amorphous sheets and which also makes it very difficult to form such sheets in an essentially amorphous state. In addition, because of its very rapid crystallization, this polymer does not make it possible to obtain good coalescence between sheets and results in poor adhesion properties at the contact zone.

On the basis of this observation, consideration can nevertheless be given to reducing the crystallization rate of the above homopolymer in various ways.

A first aspect is the introduction of a certain number of defects in the structure of the homopolymer consisting of the unit of formula (III), i.e., a modification of its chemical structure.

The composition may comprise, consist essentially of, or even consist of, a polymer comprising a unit of formula:

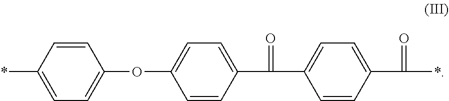

and a unit of formula:

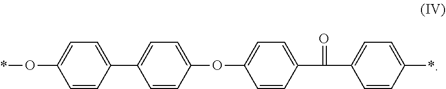

Preferentially, the polymer consists essentially of, or indeed even consists of: units of formulae (III) and (IV).

Preferentially, the polymer is, where appropriate, a random copolymer.

The molar proportion of unit (III) relative to the sum of the units (III) and (IV) may range from 0% to 99%, preferably from 5% to 95%, more preferably from 10% to 50% and most preferably from 20% to 40%.

According to some variants, the composition may comprise, consist essentially of, or even consist of, a polymer comprising, essentially consisting of, or even consisting of:
a unit of formula:

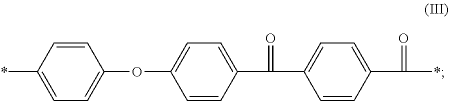

and a unit of formula:

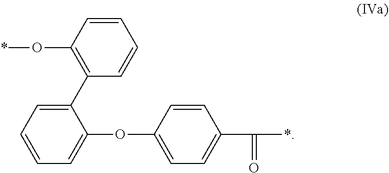

Preferentially, the polymer consists essentially of, or indeed even consists of: units of formulae (III) and (IVa).

Preferentially, the polymer is, where appropriate, a random copolymer.

The molar proportion of unit (III) relative to the sum of the units (III) and (IVa) may range from 0% to 99%, and preferably from 5% to 95%.

The composition may comprise, consist essentially of, or even consist of, a polymer comprising a unit of formula:

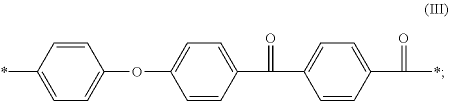

and a unit of formula:

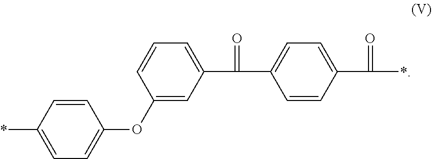

Preferably, the polymer consists essentially of, or even consists of, units of formulae (III) and (V).

Preferentially, the polymer is, where appropriate, a random copolymer.

The molar proportion of unit (III) relative to the sum of the units (III) and (V) may range from 0% to 99%, preferably from 0% to 95%.

According to some variants, the composition may comprise, consist essentially of, or even consist of, a polymer comprising, essentially consisting of, or even consisting of:
a unit of formula:

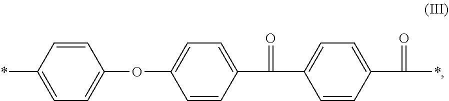

and a unit of formula:

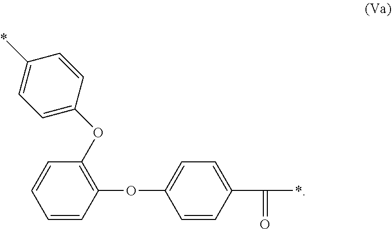

Preferably, the polymer consists essentially of, or even consists of, units of formulae (III) and (Va).

Preferentially, the polymer is, where appropriate, a random copolymer.

The molar proportion of unit (III) relative to the sum of the units (III) and (Va) may range from 0% to 99%, and preferably from 0% to 95%.

A second aspect to reduce the crystallization of a homopolymer consisting of the repeating unit of formula (III) is to mix it with another PAEK that takes longer to crystallize. This other PAEK may in particular be a PEKK essentially consisting, preferably consisting, of unit I and/or unit T or alternatively a copolymer comprising the repeating unit of formula (III), in particular those presented above.

A third aspect to reduce the crystallization rate of a PEEK homopolymer consisting of the repeating unit of formula (III) is to mix it with another polymer different from a PAEK, in particular an amorphous polymer. One amorphous polymer that is compatible with many PAEKs, in particular with a PEKK or a PEEK, is for example a polyetherimide.

A fourth aspect, not developed in detail here, to reduce the crystallization of a PEEK homopolymer consisting of the repeating unit of formula (III) would be the addition of an additive acting as an agent for modulating the rate of crystallization.

According to some particular embodiments, the composition in particular consists essentially of, or consists of, a single PAEK chosen from:
a PEKK, in particular consisting essentially, or consisting, of I and T units, as described above;
a polymer consisting essentially, or consisting, of units of formulae (III) and (IV), as described above; and
a polymer consisting essentially, or consisting, of units of formulae (III) and (V), as described above.

According to some embodiments, the composition comprises, consists essentially of, or consists of, a single PAEK, of substantially homogeneous composition and/or viscosity.

According to some embodiments, the composition comprises, consists essentially of, or consists of, several different PAEKs, that is to say in particular having a different chemical composition and/or a different viscosity.

According to some particular embodiments, the composition comprises at least two PAEKs of different chemical composition, more particularly:
a PEKK, in particular consisting essentially, or consisting, of I and T units, as described above, and in addition to this PEKK,
at least one of the following polymers: PEK, PEEKEK, PEEK, in particular a polymer consisting essentially of, or consisting of, units of formulae (III) and (V) as described above, PEEKK, PEKEKK, PEEEK, PEDEK, or a polymer essentially consisting of, or consisting of, units of formulae (III) and (IV) as described above, with a content of less than 50% by weight of the total weight of the composition, preferably less than or equal to 30% by mass of the composition.

According to some particular embodiments, the composition comprises a mixture of several PAEKs, the PAEKs being a copolymer of PAEK with different molar proportions of repeating units. In particular, the composition may comprise a mixture of PEKK copolymers having a different molar ratio of units of “T type” relative to the sum of the units of “T type” and of “I type”.

According to some particular embodiments, the composition may also comprise a mixture of several PAEKs, the PAEKs being a copolymer of PAEK with different viscosities.

Finally, the composition may also comprise a mixture of copolymers of PAEKs, the PAEKs being a copolymer of PAEK with different molar proportions of repeating units and different viscosities.

According to some embodiments, the composition may also comprise one or more other polymers not belonging to the PAEKs family, in particular other thermoplastic polymers.

According to some embodiments, the composition may comprise a mixture of PAEK(s) with at least one fluoropolymer, such as the fluoropolymers described in application EP 2 767 986 and U.S. Pat. No. 9,543,058. The fluoropolymer can preferentially be chosen from the list consisting of: a polytetrafluoroethylene (PTFE), a poly(vinyl fluoride) (PVF), a poly(vinylidene fluoride) (PVDF), a polychlorotrifluoroethylene (PCTFE), a perfluoroalkoxy polymer, a perfluoroalkoxy-alkane copolymer (PFA), a fluorinated ethylene-propylene copolymer (FEP), a poly(ethylene-co-tetrafluoroethylene) (ETFE), polyethylenechlorotrifluoroethylene (ECTFE), a perfluorinated elastomer (FFKM), a perfluoropolyether (PFPE), and a mixture thereof.

Since the fluoropolymers are generally immiscible with the PAEKs, the composition is, in these embodiments, advantageously a dispersion of particles of fluoropolymers in said at least one PAEK.

According to some embodiments, the composition comprises a mixture of PAEK(s) and a polyetherimide (PEI), a silicone-polyimide copolymer or alternatively a polysiloxane/polyimide (such as a polyetherimide/polydimethylsiloxane (PEI/PDMS)) block copolymer, such as the polymers described in applications EP 0 323 142 and U.S. Pat. No. 8,013,251.

According to some embodiments, the composition may comprise alternatively to or in addition to the abovementioned thermoplastics: a polyphenylene sulfone (PPSU), a polysulfone (PSU), a polycarbonate (PC), a polyphenylene ether (PPE), a poly(phenylene sulfide) (PPS), a poly(ethylene terephthalate) (PET), a polyamide (PA), a polybenzimidizole (PBI), a poly(amide-imide) (PAI), a poly(ether sulfone) (PES), a poly(aryl sulfone), a poly(ether imide sulfone), a polyphenylene, a polybenzoxazole, a polybenzothiazole, a mixture thereof.

According to some particular embodiments, the composition consists essentially of, or consists of, a mixture of:
PAEK chosen from: a PEKK, in particular consisting essentially of, or consisting of, units I and T, as described above; a polymer consisting essentially of, or consisting of, units of formulae (III) and (IV), as described above; and a polymer consisting essentially of, or consisting of, units of formulae (III) and (V), as described above;
with another polymer chosen from the list consisting of:
   FEP, PFA, FFKM, PEI, PEI/PDMS, PES, PSU, PPSU, PPS, PPE and a mixture thereof.

In particular, the composition may consist essentially of, or consist of, a mixture of:
PEKK, consisting essentially, or consisting, of I and T units, in which
   the molar proportion of T units relative to the sum of the T and I units ranges from 45% to 75%;
with another polymer chosen from the list consisting of: FEP, PFA, FFKM, PEI, PEI/PDMS, PES, PSU, PPSU, PPS, PPE and a mixture thereof.

According to some embodiments, the composition can additionally comprise fillers and/or additives.

Among the fillers, mention may be made of fillers of mainly reinforcing type, in fibrous or non-fibrous form. The non-fibrous fillers may in particular be titanium dioxide, talc or calcium carbonate. The fibrous fillers may in particular be glass fibers and carbon fibers, which may or may not be ground.

Among the fillers, mention may be made of fillers of mainly heat-conducting type, and in particular of fillers which may be chosen from the list consisting of: ceramics, such as boron nitride or aluminum oxide, metals, such as copper, stainless steel, aluminum, gold, silver, carbon fillers, such as carbon black, carbon nanotubes, graphite, mineral fillers, such as hematite, or a mixture thereof.

The composition can thus comprise less than 50% by weight of fillers, preferably less than 40% by weight of fillers and more preferably less than 25% by weight of fillers, with respect to the total weight of the composition.

Additives include stabilizing agents (light, in particular UV, and heat such as phosphate salts), optical brighteners, dyes, pigments, flow agents, additives for adjusting the melt viscosity of the composition, additives for adjusting the crystallization rates of the composition, additives for adjusting the heat capacity of the composition, or a combination of these additives. The composition may thus comprise less than 10% by weight, preferably less than 5% by weight and even more preferably less than 1% by weight of additive(s) relative to the total weight of the composition.

### Sheet Comprising the Composition on at Least One Face Thereof

A sheet is a three-dimensional article that is typically flat or substantially planar and has a thickness that is significantly less than both its length and its width. In particular, a sheet may have a thickness of less than 10%, or less than 5%, relative to both its length and its width.

The sheet may be non-porous, porous, microporous, etc., depending on the intended application and use.

According to some embodiments, the sheet may consist of the pseudo-amorphous composition based on polyaryl ether ketone(s).

According to some embodiments, the sheet may be formed by a multiplicity of layers, that is to say at least two layers, each layer possibly having independently of one another a different chemical composition or not. In this embodiment, the composition based on polyaryl ether ketone(s) is then used to form a layer at the periphery of the multiplicity of layers, i.e. on at least one of the two faces of the sheet.

According to some embodiments, each sheet may consist of two layers. One advantageous example of a two-layer sheet is a sheet consisting of a first PEKK layer consisting of repeating T:I units and having a T:I molar ratio of about 70:30 and a second PEKK layer consisting of repeating T:I units and having a T:I molar ratio of about 60:40, the PEKK having a T:I ratio being advantageously used to constitute the inner face of a sheet.

The thickness of the sheet can be measured, for example, using a standard micrometer.

The sheet, or where appropriate the layer consisting of the composition based on polyaryl ether ketone(s), may in particular have a thickness ranging from 200 microns to 20.00 millimeters. Preferably, the sheet has a thickness ranging from 500 microns to 10.00 millimeters.

According to particular embodiments, the sheet, or where appropriate the layer consisting of the composition based on polyaryl ether ketone(s), has a thickness equal to a value ranging from 500 microns to 1000 microns, or has a value ranging from 1.00 millimeter to 2.00 millimeters, or has a value ranging from 2.00 millimeters to 3.00 millimeters, or has a value ranging from 3.00 millimeters to 4.00 millimeters, or has a value ranging from 4.00 millimeters to 5.00 millimeters, or has a value ranging from 6.00 millimeters to 7.00 millimeters, or has a value ranging from 8.00 millimeters to 9.00 millimeters, or has a value ranging from 9.00 millimeters to 10.00 millimeters.

In general, the thickness of the sheet is substantially uniform, that is to say its thickness may vary from one location on the sheet to another by at most about 10%, preferably at most about 5%.

The sheet, or where appropriate the layer consisting of the composition based on polyaryl ether ketone(s), may be manufactured by methods known per se comprising:
a step of heating the composition based on polyaryl ether ketone(s) to an appropriate temperature above its melting temperature, to provide a molten resin composition;
a step of forming the molten resin composition into a sheet; and
a step of quenching the sheet at a speed fast enough to obtain a sheet in a pseudo-amorphous state.

In some embodiments, the sheets used in the present invention may be manufactured by melt extrusion. The extrusion temperature will depend on the melting temperature of the polymer (which, in the case of a PEKK, is influenced by its T:I ratio) and also on its melt viscosity. For example, when the ratio of the T:I isomers in a PEKK is 70:30 or 50:50, the preferred extrusion temperature is between about 350° C. and about 380° C. In general, extrusion temperatures of about 5° C. to about 70° C., or of about 10° C. to about 50° C., above the melting temperature of the composition are suitable temperatures.

The extruded sheet is transported from the die directly onto polished metal or textured cylinders, commonly known as “cooling cylinders”, because the surface temperature of these cylinders is maintained below the melting temperature of the polymer. A stream of air or other gas may also be directed to the extruded sheet to facilitate its cooling. The speed at which the sheet is cooled (called quenching speed) and solidified is an important aspect in obtaining a pseudo-amorphous sheet structure. The quenching speed is largely determined by the temperature of the cooling cylinders, the thickness of the sheet and the speed of the line. It must be fast enough for the sheet to be obtained in a pseudo-amorphous state.

### Twin Sheet Thermoforming Process

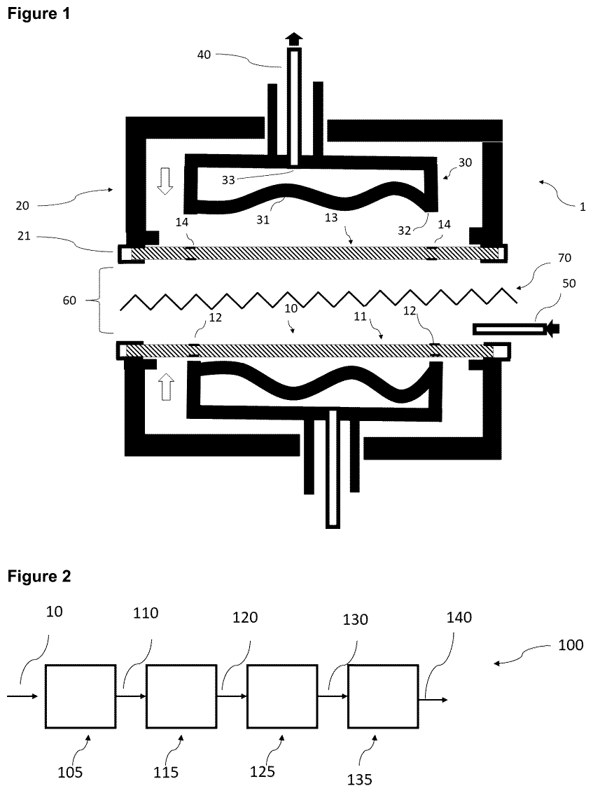

FIG. 1 schematically presents a device 1 adapted for a twin sheet thermoforming process according to the invention, in particular for the process described by the block diagram of FIG. 2.

With reference to FIG. 1, the device 1 comprises a frame 20 comprising clamping means 21 capable of fixing two sheets 10 to it. The two sheets 10 are initially substantially parallel to each other and separated by an inter-sheet space 60.

The sheets 10 each comprise an internal face 11 consisting of a pseudo-amorphous composition based on polyaryl ether ketone(s). The internal faces 11 of the two sheets 10 face each other and are capable of being brought into contact, at least partially, with each other at a contact zone 12 during the contacting and coalescing step.

The device 1 also comprises two mold halves 30 comprising walls 31, the shape of which is adapted to the desired final shape of the hollow body to be manufactured.

Each mold half 30 can be, independently of each other, flat, positive or negative in shape.

According to advantageous embodiments, one of the two mold halves is of negative shape. The other mold half can then be a plate, of positive shape, or of negative shape. The other mold half may in particular be a plate or of negative shape.

The mold halves 30 can be moved (direction of the arrows) from an open position (FIG. 1), away from each other, to a closed position (not shown), so that the walls 31 form a cavity. It is this cavity that gives the manufactured article its “hollow body” attribute.

The external faces 13 of the two sheets 10 face their respective mold half 30. They are capable of being brought into contact at a pinching zone 14 with parts 32 of the half-molds 30 intended to ensure closure by pinching.

The parts 32 of the half-molds 30 may be planar or, on the contrary, may have a shape that makes it possible to increase the contact surface at the pinching zone 14.

Each mold half 30 may comprise holes 33 allowing the gases to escape during at least the forming step. These holes 33 can advantageously be connected to a gas outlet tube 40 through which the vacuum can be drawn so as to allow, at least in part, the sheets 10 to be formed. Alternatively and/or in addition, the sheets can be formed, at least in part, by injection of pressurized gas, by means of a gas inlet tube 50 which can be inserted, at least temporarily, at the inter-sheet space 60. The gas may optionally be heated so that the sheets 10 maintain a temperature sufficiently close to the softening temperature during the forming step.

Each sheet may be heated on its external face 13 and/or on its internal face 11 using a means of heating by radiation, convection or conduction, making it possible to soften it. Heating can be carried out, for example, with infrared lamps and/or by blowing hot air and/or in an oven. The heating means are arranged so that each sheet softens as uniformly as possible.

According to one embodiment, shown in FIG. 1, a heating means 70 can be disposed at the inter-sheet space 60, thus enabling the internal face 11 of the two sheets 10 to be heated during the softening step. In addition (not shown in the diagram of FIG. 1), additional heating means can be used, at least temporarily, to heat the external faces of the sheets 10.

This may in particular be made necessary in the case where the sheet is very thick.

Also in addition (not shown in the diagram of FIG. 1), additional heating means may be used so as to heat, in embodiments where the contacting temperature is greater than the softening temperature, the contact zones 12 of at least one or both sheets 10. According to some embodiments, this complementary heating mode can be implemented by conduction by bringing the part of the half-mold 32 into contact with the pinching zone 14 of one of the two sheets 10 for a sufficient period of time. These complementary heating means are arranged so that the pinching zones 14 have a temperature that is as uniform as possible.

The device according to FIG. 1 is in particular adapted to implement a twin sheet thermoforming process 100 according to a process whose block diagram is shown in FIG. 2.

With reference to FIG. 2, the process 100 comprises the provision of two sheets 10 comprising at least one face 11 consisting of a pseudo-amorphous composition based on polyaryl ether ketone(s).

The process 100 comprises a step 105 of softening each of the sheets at a softening temperature, so as to form softened sheets 110.

The softening temperature may otherwise be referred to as the “thermoforming temperature”.

The softening temperature is greater than or equal to the glass transition temperature of each pseudo-amorphous composition.

According to the embodiments in which the composition of the sheets is different, the softening temperature may be different for each sheet. Conversely, according to the embodiments in which the composition of the sheets is similar, the softening temperature of each sheet may be similar.

The softening temperature can be measured with the aid of a thermocouple in the vicinity of the internal face 11 of a sheet 10 (outside the contact zone 12).

The softening temperature generally has a value strictly greater than T_{g} and less than or equal to (T_{g}+80° C.) The softening temperature may preferably be from (T_{g}+10°) C to (T_{g}+75° C.)

According to some embodiments, the softening temperature may be from (Tg+15°) C to (Tg+65°) C or from (Tg+20°) C to (Tg+60° C.)

Advantageously, the softening temperature is substantially homogeneous over the entire internal face 11 of each sheet 10, except possibly at the contact zones 12 and adjacent zones, if a contact temperature different from the softening temperature is imposed.

For example, for PEKK consisting essentially of, or consisting of, repeating units T and I and having a molar ratio T:I equal to about 70%, the softening temperature can be from 175° C. to 225° C. In the case where the softening temperature is equal to the contacting temperature of the contacting zones, a temperature of 195° C. to 215° C. may advantageously be chosen.

When the sheets 10 have reached their softening temperature, the heating element 70 can be withdrawn from the inter-sheet space 60.

The process 100 comprises a step 115 of forming the softened sheets 110. The forming can in particular be carried out by blowing a pressurized gas onto the internal faces 11 and/or by sucking air onto the external faces 13.

For example, a pressure of 1 to 6 bar, preferably 1.2 to 5 bar, can be exerted on the internal faces 11 and/or a vacuum of 0.001 to 0.9 bar, preferably 0.05 to 0.85 bar, can be exerted on the external faces 13.

The process 100 comprises a step 125 of contacting and coalescing at least one contact zone 12 of said faces 11 of the softened sheets so as to form an intermediate body 130. For the contacting and coalescence step, the contact zones 12 are heated to a contacting temperature, each contact zone 12 remaining in an essentially amorphous state at least until contacting. The contact step is carried out by bringing the half-molds 30 together so that the parts of the half-mold 32 first come into contact with the sheets 10 at the pinching zones 14, then bringing the two sheets 10 into contact at their contact zone 12. The coalescence of the two sheets 10 is made possible by the fact that the composition of the internal faces 11 constituting them is in an essentially amorphous state at the time of bringing the contact zones 12 into contact.

The contact temperature can be measured using a thermocouple in the vicinity of a contact zone 12 of a sheet 10.

The contact temperature is generally greater than or equal to the softening temperature.

The contact temperature is generally less than or equal to the mold temperature.

According to some embodiments, the contact temperature may be equal to about the softening temperature.

According to some embodiments, the contact temperature may be equal to about the mold temperature.

According to some embodiments, the contact temperature may be a few degrees or a few tens of degrees higher than the softening temperature.

The contact temperature may in particular be at least 5° C., or at least 10° C., or at least 15° C. higher than the softening temperature.

The contact temperature may in particular be at most 75° C., or at most 60° C., or at most 50° C., or at most 45° C., or at most 40° C., or at most 35° C., or at most 30° C., or at most 25° C. or at most 20° C. higher than the softening temperature.

According to some embodiments, the contact temperature may be a few degrees or a few tens of degrees lower than the mold temperature. These embodiments can in particular be implemented when the part 32 of a half-mold 30 is brought into contact for a sufficient period of time with the pinching zone 14 before the step of contact and coalescence of the contact zones 12 of the sheets 10.

The contact temperature may in particular be at most 5° C., or at most 10° C., or at most 15° C. lower than the mold temperature.

In order to facilitate the coalescence of the contact zones 12, a pinching pressure can be exerted on the two half-molds 30. According to some embodiments, the pinching pressure is from 1 bar to 50 bar. The pinching pressure may preferably be from 5 bar to 40 bar and even more preferably from 7 to 30 bar. The pinching pressure can be adapted by providing an air gap between the two half-molds.

The process 100 lastly comprises a step 135 of crystallizing the composition based on polyaryl ether ketone(s) at a mold temperature, so as to form a crystallized hollow body after the contacting and coalescing step 115 and after the forming step 125, to form a crystallized hollow body 140.

The mold can be brought to the mold temperature, preferably as uniform as possible, by means of suitable mold heating means, for example electric heating devices.

The mold temperature may advantageously be a temperature close to the temperature at which the composition exhibits a minimum isothermal crystallization half-time.

According to some embodiments, the mold temperature may be close to (T_{g}+T_{f})/2. The mold temperature is preferably not more than 35° C., or not more than 25° C., or not more than 15° C., or not more than 10° C. above (T_{g}+T_{f})/2. The mold temperature is preferably not less than 45° C., or 35° C., or 25° C., or 20° C. below (T_{g}+T_{f})/2.

For example, for PEKK consisting essentially of, or consisting of, repeating units T and I and having a T:I molar ratio equal to about 70%, the mold temperature may be from 210° C. to 270° C., and preferably from 220° C. to 260° C., and more preferably from 225° C. to 255° C.

Advantageously, the difference between the softening temperature and the mold temperature can be less than or equal to 60° C., so as to avoid any warping. The difference between the softening temperature and the mold temperature may in particular be less than or equal to 50° C., or else less than or equal to 40° C.

Also advantageously, the difference between the softening temperature and the mold temperature may be greater than or equal to 15° C., or greater than or equal to 20° C., or even greater than or equal to 25° C.

The duration of the crystallization step may depend on the thickness of the sheets, the mold temperature, the shape of the mold and the desired degree of crystallization. For example, for PEKK consisting essentially of, or consisting of, repeating units T and I and having a molar ratio T:I equal to about 70%, this duration may be from 1 minute to 30 minutes, preferably from 2 minutes to 15 minutes, and more preferably from 3 minutes to 10 minutes.

According to some embodiments, sufficiently long heating of the contact zone makes it possible to achieve an average degree of crystallinity strictly greater than 7%, as measured by WAXS. Preferably, it makes it possible to achieve a degree of crystallinity greater than or equal to 10%, or greater than or equal to 15%, or greater than or equal to 20%, or even greater than or equal to 25%.

Although the block diagram of FIG. 2 represents steps of sequential type, some of these steps may in practice overlap and/or take place simultaneously, or even in a different order.

According to some embodiments, the step 115 of forming the sheets 10 can be initiated before the contacting and coalescing step 125 by initiating a blowing of air and/or a vacuum suction before the contact zones 12 have been brought into contact. According to these embodiments, the forming step 115 can be carried out so as to end before, at the same time as, or after the contacting and coalescing step.

According to particular embodiments, the forming step 115 can end before the contacting and coalescing step 125. This is particularly the case when the sheets are formed one by one and then brought into contact with each other.

According to some embodiments, the forming step 115 can end approximately at the same time as the contacting and coalescing step 125.

According to some embodiments (not shown in FIG. 2), the forming step can be carried out essentially after the contacting and coalescing step.

Although the crystallization step may, to some extent, be initiated before the end of the contacting step and/or before the end of the forming step, it is essential for the implementation of the invention that the composition be in an essentially amorphous state for bringing the contact zones of the sheets into contact and coalescence. It is also advantageous for the forming step to be carried out with an essentially amorphous composition.

Hollow bodies that can be used according to the invention are innumerable and can have more or less complex shapes. Among the possible hollow bodies, mention may in particular be made of objects of the “reservoir” type or objects of the “casing” or “case” type.

### EXAMPLES

### Example 1

A hollow body was manufactured using a device as shown schematically in FIG. 1 by a process according to the block diagram in FIG. 2.

Two amorphous sheets 2.3 millimeters in thickness consisting of a polyetherketoneketone consisting of T and I units with a molar ratio of 70:30 and a viscosity at 380° C., at 1 Hz, of 3906 Pa·s are used.

The internal face of the sheets is heated to a softening temperature of 210° C. for the softening step. No additional heating means are used to heat the inter-sheet contact zones.

The two half-molds are closed with a pinching pressure of 10 bar.

The two sheets are thermoformed and maintained for about 5 minutes in a mold heated to a temperature of 240° C. The mold is then opened by removing one of the two half-molds and the hot hollow body is cooled by air jet.

The hollow body thus obtained is opaque in appearance, meaning that it is crystallized.

### Example 2

A hollow body was manufactured with the same sheets as those used in example 1.

The internal face of the sheets is heated to a softening temperature of 200° C. for the softening step. The contact zones are brought to a temperature of 220° C.

The two half-molds are closed with a pinching pressure of 10 bar.

The two sheets are thermoformed and maintained for about 5 minutes in a mold heated to a temperature of 240° C. The mold is then opened by removing one of the two half-molds and the hot hollow body is cooled by air jet.

The hollow body thus obtained is opaque in appearance, meaning that it is crystallized.

1. A twin sheet thermoforming process for manufacturing a hollow body, said process comprising:
supplying two sheets comprising at least one face consisting of a pseudo-amorphous composition based on polyaryl ether ketone(s);
a step of softening the two sheets at a softening temperature, so as to form softened sheets,
the softening temperature being greater than or equal to the glass transition temperature of each pseudo-amorphous composition;
a step of forming the softened sheets so as to form thermoformed sheets;
a step of contacting and coalescing at least one contact zone of said faces of the softened sheets, and/or
of sheets being formed or already formed,
so as to form an intermediate body, the contact zones being heated to a contacting temperature, each contact zone remaining in an essentially amorphous state at least until contacting; and
a step of crystallizing the composition at a mold temperature, to form a crystallized hollow body,
the crystallization step being carried out essentially after the contacting and coalescing step.

2. The twin sheet thermoforming process as claimed in claim 1, wherein said composition has a viscosity at 380° C., at 1 Hz, as measured by a parallel plate rheometer, ranging from 200 Pa·s.

3. The thermoforming process as claimed in claim 1, wherein the isothermal crystallization half-time at the contact temperature is at least 3 seconds; and/or
wherein the isothermal crystallization half-time at the contact temperature is not more than 30 minutes.

4. The twin sheet thermoforming process as claimed in claim 1, wherein the at least one polyaryl ether ketone is a polyether ketone ketone.

5. The twin sheet thermoforming process as claimed in claim 1, wherein the at least one polyaryl ether ketone is a copolymer consisting essentially of a repeating unit of chemical formula: 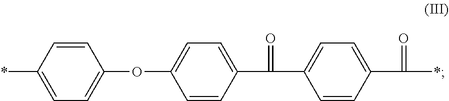
and a repeating unit of chemical formula: 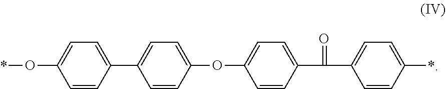
the molar percentage of unit (III), relative to the sum of the units (III) and (IV), being from: 0% to 99%.

6. The twin sheet thermoforming process as claimed in claim 1, wherein the at least one polyaryl ether ketone is a copolymer consisting essentially of a repeating unit having the formula: 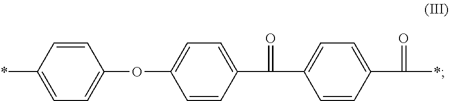
and a repeating unit having the formula: 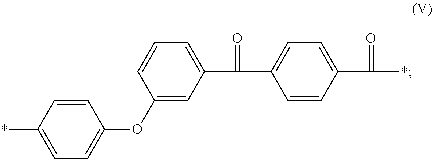
the molar percentage of unit (III), relative to the sum of the units (III) and (V), being from 0% to 99%.

7. The twin sheet thermoforming process as claimed in claim 1, wherein the composition consists of polyaryl ether ketone(s), optionally other thermoplastic polymer(s) different from a polyaryl ether ketone, optionally filler(s), and optionally additive(s).

8. The twin sheet thermoforming process as claimed in claim 1, wherein each sheet consists, independently or not of each other, of a pseudo-amorphous composition based on polyaryl ether ketone(s).

9. The twin sheet thermoforming process as claimed in claim 1, wherein the two sheets have, independently or not of each other, a thickness of 200 microns to 20 millimeters.

10. The twin sheet thermoforming process as claimed in claim 1, wherein the crystallization step is carried out to an average degree of crystallinity in the thickness of strictly greater than 7%, as measured by WAXS, during the crystallization step.

11. The twin sheet thermoforming process as claimed in claim 1, wherein the softening step is carried out at a softening temperature having a value strictly greater than Tg and less than or equal to (Tg+80)° C.

12. The twin sheet thermoforming process as claimed in claim 1, wherein the crystallization step is carried out at a mold temperature close to the temperature at which the composition exhibits a minimum isothermal crystallization half-time.

13. The twin sheet thermoforming process as claimed in claim 1, wherein the difference between the mold temperature and the softening temperature is less than or equal to 60° C., and/or greater than or equal to 15° C.

14. The twin sheet thermoforming process as claimed in claim 1, wherein the contacting and coalescing step is carried out with a pinching pressure having a value ranging from 1 bar to 50 bar.

15. A hollow body comprising at least one internal surface consisting of a crystallized composition based on polyaryl ether ketone(s), obtainable by a process as claimed in claim 1.
